(19) United States
(12) Patent Application Publication
(10) Pub. No.: US 2020/0078827 A1
(43) Pub. Date: Mar. 12, 2020

(54) MAGNETIC SCREEN LINING FASTENING SYSTEM

(71) Applicant: Siebtechnik GmbH, Mülheim (DE)

(72) Inventors: Matthias COPPERS, Essen (DE); Jürg POLLMANNS, Niederkrüchten (DE)

(73) Assignee: Siebtechnik GmbH, Mülheim (DE)

(21) Appl. No.: 16/615,875

(22) PCT Filed: May 3, 2018
(86) PCT No.: PCT/EP2018/000237

§ 371 Date: Nov. 22, 2019

(30) Foreign Application Priority Data
May 22, 2017 (EP) 17000871.8

(51) Int. Cl. B07B 1/46; B03B 5/24

(52) U.S. Cl. CPC B07B 1/4645; B07B 2201/02; B03B 5/24

(57) ABSTRACT

A fastening system for screening machines and/or setting machines for fastening replaceable screen lining segments and/or replaceable anti-wear elements in or to a screening machine having at least one frame which receives the screen lining segments and/or supports the anti-wear elements. For fastening of a screen lining segment and/or of an anti-wear element at least one adapter is fastened to the frame, the adapter having at least one magnet. The magnet interacts with the frame and/or with at least one ferromagnetic coupling element arranged in a vibration-proof manner in or on the screen lining segment and/or anti-wear element and in this way produces a magnetic connection between the adapter and the frame and/or between the adapter and the screen lining segment and/or anti-wear element. Additionally, a screening machine having such a fastening system.

The invention relates to a fastening system for screening machines and/or jigs for fastening exchangeable screen lining segments and/or exchangeable wear protection elements in or on a screening machine comprising at least one frame that receives the screen lining segments and/or supports the wear protection elements.

Fastening systems of this kind, and screening machines comprising exchangeable screen lining segments fastened thereto, and exchangeable wear protection elements, are known. In this case, the screen lining segments and wear protection elements are fastened to corresponding receptacles of the screening machine or jigs by means of screw connections or plug-in connections.

The known fastening systems are therefore disadvantageous in that laborious dismounting and mounting is required for dismounting worn screen lining segments and wear protection elements and replacing these with new screen lining segments and wear protection elements which often have to be mounted using a high degree of force and in extremely restricted space.

The object of the invention is that of overcoming these disadvantages and specifying a screen lining fastening system that allows for simple dismounting and mounting of screen lining segments and wear protection elements on a screening machine.

This object is achieved according to the invention by a fastening system according to claim 1. Advantageous developments of the invention are specified in the dependent claims.

A particular advantage in the fastening system for screening machines for fastening exchangeable screen lining segments and/or exchangeable wear protection elements in or on a screening machine comprising at least one frame that receives the screen lining segments and/or supports the wear protection elements is that, in order to fasten a screen lining segment and/or a wear protection element, at least one adapter is fastened to the frame, wherein the adapter comprises at least one magnet, wherein the magnet interacts with the frame and/or with at least one ferromagnetic coupling element that is arranged in or on the screen lining segment and/or wear protection element so as to be vibration-resistant, and thereby establishes a magnetic connection between the adapter and the frame and/or between the adapter and the screen lining segment and/or wear protection element.

Within the meaning according to the invention, the terms screening machine and jig are used synonymously.

Therefore, according to the invention, the screen lining segments and wear protection elements that are subject to wear are fastened to adapters by means of a magnetic coupling, wherein each adapter comprises at least one magnet, respectively, which magnet establishes a magnetic connection to a ferromagnetic coupling element that is associated with the screen lining segment and/or wear protection element. The adapter comprising the magnet remains on the frame of the screening machine each time a worn screen lining segment or wear protection element is exchanged. In order to exchange a wearing part, it is only necessary for the magnetic connection to be released and for a new screen lining segment and/or wear protection element to be placed on. The screen lining segments and/or wear protection elements are thus magnetically fastened to the screening machine.

Alternatively or cumulatively, the adapter itself can be magnetically secured to the frame of the screening machine. The exchangeable screen lining segments and/or the exchangeable wear protection elements can be indirectly or directly fastened to the adapter, in a magnetic and/or form-fit and/or force-fit manner. Fastening of the adapter that is easy to mount and dismount is achieved by magnetic fastening of the adapter to the frame of the screening machine.

The magnetic and/or form-fit and/or force-fit fastening of the screen lining segments and/or wear protection elements to the adapter can take place indirectly or directly.

The screen base can also be formed by a single integral screen lining segment. The invention is therefore not restricted to an application having a screen base formed of a plurality of screen lining segments, even if this is a preferred embodiment.

This ensures that the screen lining segments and/or wear protection elements that are considered as wearing parts can be fastened by means of the magnetic interaction between the at least one magnet of the adapter fastened to the frame of the screening machine, and the at least one ferromagnetic coupling element arranged in or on the screen lining segment and/or wear protection element. As a result, the screen lining segments and/or wear protection elements can be dismounted and mounted in a simple manner. Furthermore, an adapter strip can be retrofitted to pre-existing screening machines without significant effort, with the result that no changes need to be made to the screening machine itself.

The adapter is preferably fastened to a component of the screening machine that is made of a non-ferromagnetic material. In particular, the adapter may be fastened in a force-fit and/or cohesive and/or form-fit manner. Stainless steel, for example, is a non-ferromagnetic material. Furthermore, the adapter can thus function as a fastening and connection element, by itself being fastened to non-magnetic surfaces and components, for example made of stainless steel. Such an arrangement of the adapter comprising at least one magnet also allows for magnetic fastening of screen lining segments and/or wear protection elements to components made of a non-ferromagnetic material.

As an alternative to fastening the adapter to a component of the screening machine that is made of a non-ferromagnetic material, the adapter can be fastened to a ferromagnetic component of the screening machine. In particular, the adapter may be fastened in a magnetic and/or force-fit and/or cohesive and/or form-fit manner. In particular, the adapter can comprise magnets that act on both sides, by means of which the adapter itself is magnetically fastened to a ferromagnetic component of the screening machine and which at the same time are used to interact with at least one ferromagnetic coupling element that is arranged in or on the screen lining segment and/or wear protection element in a vibration-resistant manner, and to thereby establish a magnetic connection between the adapter and the screen lining segment and/or wear protection element. In the case of the arrangement of magnets that act on both sides, the magnets are used both for magnetic fastening of the adapter to the screening machine and for magnetic fastening of the screen lining or of the wear protection elements to the adapter.

In particular, adapters of this kind can also be attached to side parts of screening machines and be used for fastening lateral wear protection elements. Said side parts can for example be vertical boundary walls above the screen base. Furthermore, said adapters may be adapters for shaft protection tubes which are laid around the tube, adhere magnetically there, and in turn magnetically hold a wear protection element that is laid around the tube.

The adapter can in particular be designed as an elongate adapter strip. The frame of the screening machine, which frame receives the adapters or adapter strips, can be formed by X-profiles and/or C-profiles and/or U-profiles and/or T-profiles and/or KR-profiles and/or angle sections. The adapter can be formed by a plastics component, in particular as an injection molded part comprising one or more molded magnets. The adapter may comprise bores, in particular for receiving fastening dowels for fastening the adapter to what are known as KR-profiles and/or angle sections.

The adapter can be fastened to the frame of the screening machine in particular in a force-fit and/or cohesive and/or form-fit manner. In this case, the term “the frame of the screening machine” covers any component of the screening machine to which an exchangeable screen lining segment and/or an exchangeable wear protection element is fastened, in particular indirectly.

A particular advantage of the invention is therefore that the fastening system for screening machines for fastening exchangeable screen lining segments and/or exchangeable wear protection elements can be retrofitted by arranging adapters on existing screening machines, since the adapters can be fastened to the receptacles and fastening locations originally provided for the screen lining segments and/or wear protection elements. In this case, the magnets are arranged in or on the adapters remaining on the screening machine.

Preferably, each adapter comprises a plurality of magnets that are in particular arranged so as to be equidistant. Arranging a plurality of magnets at each adapter, in particular in the case of adapters in the form of elongate adapter strips, makes it possible for the magnetic holding force to be increased and to be exerted uniformly, for example along the edges of the screen lining segments and/or wear protection elements that are to be fastened.

In a preferred embodiment, one or more ferromagnetic coupling elements are molded in each screen lining segment and/or each wear protection element, and/or the ferromagnetic coupling element is formed by the screen lining segment and/or the wear protection element itself. In particular, the screen lining segments and/or the wear protection elements can be formed by polyurethane, in which ferromagnetic coupling elements are molded. The ferromagnetic coupling elements can at the same time form mechanical reinforcements in the screen lining segments and/or wear protection elements. This means that the ferromagnetic coupling elements molded into the screen lining segments and/or wear protection elements simultaneously for reinforcements of the screen lining segments and/or wear protection elements. Vice versa, the metal reinforcements provided in any case in the screen lining segments and/or wear protection elements in order to increase the bearing resistance can simultaneously function as ferromagnetic coupling elements for establishing the magnetic connection to the magnets of the adapters or adapter strips.

Preferably, one or more ferromagnetic coupling elements are formed by mounting rails and/or mounting frames, which are magnetically secured to the adapter, wherein screen lining segments and/or wear protection elements are secured to the mounting rails and/or mounting frames in a force-fit and/or form-fit manner and so as to be vibration-resistant.

It is thus possible for one or more mounting rails and/or mounting frames made of ferromagnetic material to be arranged for establishing the magnetic connection to the adapters, wherein the screen lining segments and/or wear protection elements are fastened to the mounting strips and/or mounting frames in a force-fit and/or form-fit manner and so as to be vibration-resistant, and in particular so as to be exchangeable.

Furthermore, the screen lining segment can in particular be formed by a perforated metal plate made of ferromagnetic material. The screen lining segments can in particular be formed by a ferromagnetic perforated metal plate comprising a polyurethane layer sprayed thereon. In the case of a coated perforated metal plate, the coating applied to the perforated metal plate may have a different, in particular smaller, mesh size than the perforated metal plate that functions as the support.

The ferromagnetic coupling element can be formed of iron or an iron alloy. As a result, a favorable solution is provided, having a particularly good magnetic holding force. As explained above, the ferromagnetic coupling element can in particular be formed by a molded iron core in the screen lining segment and/or wear protection element, in particular the ferromagnetic coupling element can be molded into the material of the screen lining segment and/or of the wear protection element, in the form of a strut and/or a frame, and form a reinforcement element for reinforcing the screen lining segment and/or the wear protection element. In particular, the screen lining segment and/or the wear protection element can be reinforced by means of the ferromagnetic coupling element.

The wearing parts are therefore merely associated with the ferromagnetic coupling elements, which are cheaper than magnets, for example in the form of iron cores, which elements can be reused in a simple manner. The screen lining segments and/or wear protection elements themselves can be formed of non-ferromagnetic material, in particular polyurethane.

In a preferred embodiment, the ferromagnetic coupling element of a screen lining segment is formed by a perforated metal plate made of ferromagnetic material, which plate forms a support for screen media, in particular fabric. In this case, a perforated metal plate made of ferromagnetic material is fastened to the adapters by means of the magnetic coupling and functions as a support for screen media, for example fabric and the like, fastened to the perforated metal plate. When worn screen media are exchanged, the ferromagnetic perforated metal plate is used again as a support, and merely the screen medium, such as a fabric, fastened thereto is replaced.

The ferromagnetic coupling element is preferably designed so as to be in parallel with the course of an elongate adapter, continuously or in sections. In particular, the ferromagnetic coupling element can follow the edge profile of a screen lining segment and/or a wear protection element, in order to ensure good and reliable fastening of the relevant screen lining segment and/or wear protection element, specifically in the edge region. In this case, the course of the elongate adapter preferably also follows the edge profile of a screen lining segment and/or a wear protection element, in order to ensure the magnetic fastening of the relevant screen lining segment and/or wear protection element, specifically in the edge region.

The ferromagnetic coupling element can be formed in one piece or in multiple parts, in particular as a molded core which is embedded in the matrix of a screen lining segment and/or wear protection element. In this case, it is advantageous that the magnets do not need to be exactly positioned in order to ensure good fastening. There is therefore no need for exact and matched pairing of one magnet of the adapter with a corresponding ferromagnetic coupling element in each case, if a plurality of magnets are arranged on a for example strip-shaped adapter, and at the same time a plurality of ferromagnetic coupling elements are embedded, in sections, in the matrix of a screen lining segment and/or wear protection element, and/or a continuous iron core is arranged, for example in the form of a frame or a reinforcement. The same advantages are achieved by a reinforcement, made of ferromagnetic material, of the screen lining segment and/or wear protection element. In these cases, good and stable fastening on the magnets is ensured. In this case, the matrix of a screen lining segment and/or wear protection element can itself be formed of a flexible material, such as polyurethane.

In a preferred embodiment, a plurality of screen lining segments form a screen base. In particular, in this case, adjacent screen lining segments can in each case form a form-fit connection, in particular comprise a tongue-and-groove connection. As a result of such form-fit connections between the screen lining segments, when screen material is applied thereto a screen lining segment is also secured and fixed by the adjacent screen lining segments, in addition to the magnetic fixing.

Preferably, a plurality of screen lining segments form a screen base, wherein the last screen lining segments in the transport direction of the screen material are supported, at the end, in the transport direction, against transverse stop elements, in particular against a continuous transverse stop strip. In particular, the screen lining segments can form a form-fit connection, in particular a tongue-and-groove connection, to the transverse stop strip that extends perpendicularly to the transport direction.

Screen bases are generally positioned so as to be at an angle to the horizontal, wherein the screen material to be prepared is applied to the screen base at the geodetically higher end of the screen base, and discharged at the geodetically lower end of the screen base. In order to absorb the thrusts in the transport direction, it is therefore advantageous for the last screen lining segments in the transport direction of the screen material to be supported, at the end, against transverse stop elements. Said transverse stop elements are therefore arranged transversely to the transport direction of the screen material.

Said transverse stop elements, in particular a transverse stop strip that absorbs the thrusts, can be fastened to the frame or can be formed by the frame itself, which frame receives the screen segments. In particular, the transverse stop elements can furthermore be formed by adapters arranged at a corresponding point of the frame.

Preferably, a plurality of screen lining segments form a screen base, wherein the screen lining segments are supported laterally, in the direction perpendicularly to the transport direction of the screen material, against longitudinal stop elements, in particular longitudinal stop strips, extending in parallel with the transport direction, in particular in that the screen lining segments form a form-fit connection, in particular a tongue-and-groove connection, to the longitudinal stop strips extending in parallel with the transport direction.

Such longitudinal stop strips that are arranged laterally beside the screen lining segments, in the transport direction of the screen material, are used for absorbing transverse forces, and secure the screen lining segments laterally, in the direction perpendicularly to the transport direction. The longitudinal stop strips extend at the sides of the screen base, in parallel with the transport direction of the screen material. The longitudinal stop strips can be fastened to the frame or can be formed by the frame itself, which frame receives the screen segments. In particular, the longitudinal stop strips can furthermore be formed by adapters arranged at a corresponding point of the frame.

In a preferred embodiment, the magnet(s) and/or the ferromagnetic coupling element(s) comprise at least one undercut. Undercuts of this kind in particular form a gate edge for the production of the adapter or the screen lining segments and/or the wear protection elements from plastics material, in particular polyurethane, and facilitate the manufacturing process. Furthermore, this results in improved hold on the adapter or on the screen lining segment and/or on the wear protection element.

Preferably, the screen lining segments and/or the wear protection elements and the respective adapters for fastening the screen lining segments and/or wear protection elements form a form-fit connection, in particular a tongue-and-groove connection. A form-fit connection of this kind, in addition to the magnetic fastening of the screen lining segments and/or the wear protection elements to the respective adapters, further increases the bearing resistance of the connection of the screen lining segments and/or the wear protection elements to the adapters.

Form-fit connections of this kind between the screen lining segments and the respective adapters can be provided on the longitudinal side of the screen lining segments, i.e. on the sides of the screen lining segments that extend in the transport direction of the screen material in the installed state. Alternatively or cumulatively, form-fit connections of this kind between the screen lining segments and the respective adapters can be provided on the transverse sides of the screen lining segments, i.e. on the sides of the screen lining segments that extend perpendicularly to the transport direction of the screen material in the installed state. Such form-fit connections between the screen lining segments and the respective adapters are used for additional fixing of the screen lining segments, cumulatively to the magnetic fastening of the screen lining segments to the adapters, and prevent sliding of the screen lining segments on the adapters in the transport direction and/or perpendicularly to the transport direction of the screen material.

The adapters are preferably formed by adapter strips comprising a symmetrical arrangement of a plurality of magnets, and/or the screen lining segments have a rotationally symmetric arrangement of a plurality of ferromagnetic coupling elements and a square basic shape.

Preferably, the adapters themselves have a symmetric design. When using symmetrical adapters, these can be installed in various orientations, facilitating the mounting for the fitter.

Preferably, the screen lining segments and/or wear protection elements have a symmetric, in particular rotationally symmetric, design. When using symmetrical screen lining segments and/or wear protection elements, these can be installed in various orientations, facilitating the mounting for the fitter.

Particularly preferably, adapter strips comprising a symmetrical arrangement of a plurality of magnets, and screen lining segments having a square basic shape and a rotationally symmetric arrangement of a plurality of ferromagnetic coupling elements are combined with one another. Such a design of the adapters as adapter strips for attachment to the frame of the screening machine, and a square design of the screen lining segments and a corresponding symmetrical arrangement of the ferromagnetic coupling elements makes it possible for the screen lining segments to be fastened to the adapter strips in any desired arrangement, without a particular orientation being required for the purpose of mounting. This means that use and attachment in various directions is possible. As a result, the exchange and mounting of the screen lining segments is facilitated.

The adapter preferably comprises magnets that act on both sides, and/or the adapter is equipped with magnets on both sides, such that the adapter can be magnetically fastened to the frame, and a screen lining segment and/or a wear protection element can be magnetically fastened to the adapter. Developing the adapter such that the adapter itself is also magnetically fastened to the frame of the screening machine, and furthermore the screen lining segments and/or the wear protection elements are magnetically fastened to the adapter, allows for existing screening machines to be retrofitted in a particularly advantageous and simple manner. As a result, the adapter itself can also be magnetically fastened.

A screening machine comprising a support frame for receiving a plurality of screen lining segments for forming a screen base, in which the support frame comprises a screen lining fastening system according to the invention, is particularly advantageous.

Three embodiments of the invention are shown in the figures and are described in greater detail in the following. In the figures:

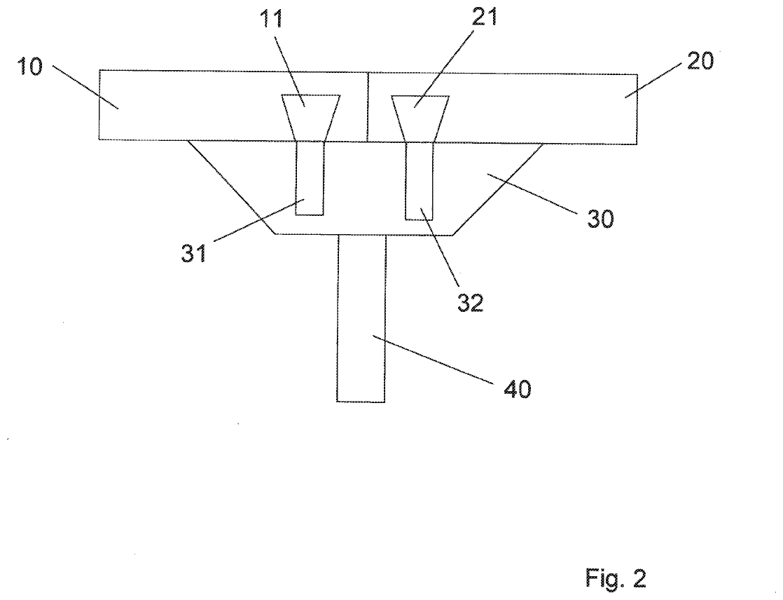

FIG. 1 is a schematic perspective view of a screen base formed of a plurality of screen lining segments;

FIG. 2 is the detail view A according to FIG. 1;

FIG. 3 shows a second exemplary embodiment comprising a frame that is formed by a C-profile and is intended for receiving the adapter strip;

FIG. 4 shows a third exemplary embodiment comprising a frame that is formed by an angle section and is intended for receiving the adapter strip.

In the figures, identical components are provided with identical reference signs.

FIG. 1 is a schematic perspective view of a screen base of a screening machine, which screen base is formed of a plurality of screen lining segments 10, 20. The screen lining segments 10, 20 are subjected to wear and are fastened on the frame 40 of the screening machine so as to be exchangeable. The transport direction of the screen material is indicated by the arrow 5. This means that the screen material to be prepared is applied at the rear end of the screen base that is located at the upper edge of the drawing in the illustration according to FIG. 1, and is transported away via the front end of the screen base that is located at the lower edge of the drawing in the illustration according to FIG. 1.

Laterally, the screen lining segments 10, 20 are supported against the longitudinal stop strips 41, 42 that extend in parallel with the transport direction 5, in order to conduct away, to the frame 40, any transverse forces acting on the screen lining segments 10, 20.

In order to absorb the thrusts in the transport direction of the screen material, the last screen lining segments 10, 20 in the transport direction of the screen material are supported, at the end, against the continuous transverse stop strip 45 of the frame 40. As a result, the thrusts acting on the screen lining segments 10, 20 are absorbed, in the transport direction of the screen material, by the frame 40 of the screening machine.

FIG. 2 is the detail view A according to FIG. 1. The frame 40 of the screening machine can be seen below the screen lining segments 10, 20. The adapter 30 is fastened to the frame 40. The adapter 30 is fastened to the frame 40 in a form-fit manner. The adapter 30 is formed of plastics material, as an injection molded part. Permanent magnets 31, 32 are inserted into the matrix of the adapter 30.

The two touching screen lining segments 10, 20 rest on the adapter 30, on the top of the adapter 30. The left-hand screen lining segment 10 in FIG. 2 comprises an iron reinforcement which forms a ferromagnetic coupling element 11 that forms a magnetic connection to the magnet 31 of the adapter. The right-hand screen lining segment 20 in FIG. 2 comprises an iron reinforcement which forms a ferromagnetic coupling element 21 that forms a magnetic connection to the magnet 32 of the adapter. The reinforcements strengthen the screen lining segments 10, 20 and extend in parallel with the support of the frame 40 on which the adapter 30, which is also formed as a strip, is fastened. The screen lining segments 10, 20 are made of polyurethane, wherein the reinforcements are molded in. As a result of the course of the reinforcements in parallel with the course of the frame 40, the screen lining segments 10, 20 are flexible, with the result that removal of the screen lining segments 10, 20 from the magnets 31, 32 is facilitated.

FIG. 3 shows a second exemplary embodiment comprising a frame 40 that is formed by a C-profile and is intended for receiving the adapter strip 30. The adapter strip 30 is formed by a plastics material. The adapter strip 30 comprises undercuts which engage behind the inwardly facing edges of the C-profile 40 and thereby fix the adapter strip 30 to the C-profile 40 in a form-fit manner. Permanent magnets 31, 32 are inserted into the matrix of the adapter 30.

The screen lining segments 10, 20 are fastened to the adapter 30 in exactly the same way as explained above, with reference to the first exemplary embodiment according to FIG. 2. The two touching screen lining segments 10, 20 rest on the adapter 30, on the top of the adapter 30. The left-hand screen lining segment 10 in FIG. 3 comprises an iron reinforcement which forms a ferromagnetic coupling element 11 that forms a magnetic connection to the magnet 31 of the adapter. The right-hand screen lining segment 20 in FIG. 3 comprises an iron reinforcement which forms a ferromagnetic coupling element 21 that forms a magnetic connection to the magnet 32 of the adapter. The reinforcements strengthen the screen lining segments 10, 20 and extend in parallel with the C-profile of the frame 40 on which the adapter 30, which is also formed as a strip, is fastened. The screen lining segments 10, 20 are made of polyurethane, wherein the reinforcements are molded in. As a result of the course of the reinforcements in parallel with the course of the frame 40, the screen lining segments 10, 20 are flexible, with the result that the removal of the screen lining segments 10, 20 from the magnets 31, 32 is facilitated.

FIG. 4 shows a third exemplary embodiment comprising a frame 40 that is formed by an angle section and is intended for receiving the adapter strip 30. The adapter strip 30 is formed by a plastics material. The adapter strip 30 comprises undercuts which engage behind the inwardly facing edges of bores in the angle section 40 and thereby fix the adapter strip 30 to the C-profile 40 in a form-fit manner. In order to secure the adapter 30 to the angle section, fastening pins 45 are used, which spread open those regions of the adapter 30 which engage through the bores in the angle section 40 after the adapter 30 has been placed on the angle section 40. The adapter 30 is thus fastened in a manner similar to that in the case of a dowel, by spreading open the connection elements and forming a form-fit connection. Permanent magnets 31, 32 are in turn inserted into the matrix of the adapter 30.

The screen lining segments 10, 20 are again fastened to the adapter 30 as explained above, with reference to the first exemplary embodiment according to FIG. 2 and the second exemplary embodiment according to FIG. 3.

The two touching screen lining segments 10, 20 rest on the adapter 30, on the top of the adapter 30. The left-hand screen lining segment 10 in FIG. 4 comprises an iron reinforcement which forms a ferromagnetic coupling element 11 that forms a magnetic connection to the magnet 31 of the adapter. The right-hand screen lining segment 20 in FIG. 4 comprises an iron reinforcement which forms a ferromagnetic coupling element 21 that forms a magnetic connection to the magnet 32 of the adapter. The reinforcements strengthen the screen lining segments 10, 20 and extend in parallel with the C-profile of the frame 40 on which the adapter 30, which is also formed as a strip, is fastened. The screen lining segments 10, 20 are made of polyurethane, wherein the reinforcements are molded in. As a result of the course of the reinforcements in parallel with the course of the frame 40, the screen lining segments 10, 20 are flexible, with the result that the removal of the screen lining segments 10, 20 from the magnets 31, 32 is facilitated.

1-14. (canceled)

15. A fastening system for screening machines and/or jigs for fastening exchangeable screen lining segments and/or exchangeable wear protection elements in or on a screening machine, comprising:
at least one frame that receives the screen lining segments and/or supports the wear protection elements,
wherein, in order to fasten a screen lining segment and/or a wear protection element, at least one adapter is fastened to the frame,
wherein the adapter comprises at least one magnet, wherein the magnet interacts with the frame and/or with at least one ferromagnetic coupling element that is arranged in or on the screen lining segment and/or wear protection element so as to be vibration-resistant, and thereby establishes a magnetic connection between the adapter and the frame and/or between the adapter and the screen lining segment and/or wear protection element,
wherein the one or more ferromagnetic coupling elements is/are molded in each screen lining segment and/or each wear protection element.

16. The fastening system according to claim 15, wherein the adapter is fastened to a component of the screening machine made of a non-ferromagnetic material, in particular in that the adapter is fastened in a force-fit and/or cohesive and/or form-fit manner

17. The fastening system according to claim 15, wherein the adapter is fastened to a component of the screening machine that is made of ferromagnetic material, in particular in that the adapter is fastened in a magnetic and/or force-fit and/or cohesive and/or form-fit manner

18. The fastening system according to claim 15, wherein each adapter comprises a plurality of magnets that are in particular arranged so as to be equidistant.

19. The fastening system according to claim 15, wherein one or more ferromagnetic coupling elements are formed by mounting rails and/or mounting frames, which are magnetically secured to the adapter, wherein screen lining segments and/or wear protection elements are secured to the mounting rails and/or mounting frames in a force-fit and/or form-fit manner and so as to be vibration-resistant.

20. The fastening system according to claim 15, wherein the ferromagnetic coupling element is designed so as to be in parallel with the course of an elongate adapter, continuously or in sections.

21. The fastening system according to claim 15, wherein a plurality of screen lining segments form a screen base, in particular wherein adjacent screen lining segments in each case form a form-fit, in particular comprise a tongue-and-groove connection.

22. The fastening system according to claim 15, wherein a plurality of screen lining segments form a screen base, wherein the last screen lining segments in the transport direction of the screen material are supported, at the end, in the transport direction, against transverse stop elements, in particular against a continuous transverse stop strip, in particular in that the screen lining segments form a form-fit, in particular a tongue-and-groove connection, to the transverse stop strip extending perpendicularly to the transport direction.

23. The fastening system according to claim 15, wherein a plurality of screen lining segments form a screen base, wherein the screen lining segments are supported laterally, in the direction perpendicularly to the transport direction of the screen material, against longitudinal stop elements, in particular longitudinal stop strips, extending in parallel with the transport direction, in particular in that the screen lining segments form a form-fit, in particular a tongue-and-groove connection, to the longitudinal stop strips extending in parallel with the transport direction.

24. The fastening system according to claim 15, wherein the magnet(s) and/or ferromagnetic coupling element(s) comprise at least one undercut.

25. The fastening system according to claim 15, wherein the screen lining segments and the respective adapters for fastening the screen lining segments form a form-fit, in particular a tongue-and-groove connection.

26. The fastening system according to claim 15, wherein the adapters are formed by adapter strips having a symmetrical arrangement of a plurality of magnets, and/or in that the screen lining segments have a rotationally symmetric arrangement of a plurality of ferromagnetic coupling elements and a square basic shape.

27. The fastening system according to claim 15, wherein the adapter comprises magnets that act on both sides, and/or is equipped with magnets on both sides, such that the adapter is able to be magnetically fastened to the frame, and a screen lining segment and/or a wear protection element can be magnetically fastened to the adapter.

28. A screening machine with a support frame for receiving a plurality of screen lining segments for forming a screen base, wherein the support frame comprises the fastening system according to claim 15.
